(19) United States
(12) Patent Application Publication
(10) Pub. No.: US 2009/0037461 A1
(43) Pub. Date: Feb. 5, 2009

(54) METHOD AND SYSTEM FOR AUTOMATIC RECOGNITION AND CATEGORIZATION OF TRANSACTIONS

(75) Inventors: Marko Rukonic, San Jose, CA (US); Suresh R. Rao, Cupertino, CA (US)

Correspondence Address: OSHA - LIANG L.L.P. (INTUIT), TWO HOUSTON CENTER, 909 FANNIN STREET, SUITE 3500, HOUSTON, TX, 77010, US

(73) Assignee: INTUIT INC., Mountain View, CA (US)

(21) Appl. No.: 11/833,206

(22) Filed: Aug. 2, 2007

(51) Int. Cl. G06F 17/30

(52) U.S. Cl. 707/103 R; 707/E17.005; 707/E17.055

(57) ABSTRACT

A method for categorization of transactions, the method including receiving a request for a transaction from a user of a plurality of users, determining an availability of an object association for an object name of an object of the transaction, wherein the object association is a preferred object association of the user, selecting a collaborative object association for the object name when the preferred object association of the user is not available, wherein the collaborative object association is selected based on the preferred object association of the plurality of users for the object name, and providing the collaborative object association to the user.

### BACKGROUND

Personal finance is related to the application of financial principles to monetary decisions of an individual or family unit. Personal finance takes into account financial risks and future events in determining how the individual or family unit obtains, budgets, saves, and spends financial resources. Components of personal finance may include the monitoring and management of bank accounts, investment accounts, retirement accounts, credit cards, consumer loans, social security benefits, insurance policies, and income tax.

Financial planning is an important aspect of personal finance. Financial planning includes the steps of assessment, goal setting, planning, execution, and monitoring and reassessment. Assessment involves the evaluation of the financial situation of an individual or a family by creating personal balance sheets and income statements. Personal balance sheets may include a list of personal assets (e.g., home, car, stocks, bonds, or other assets) and values of those assets, as well as a list of personal liabilities (e.g., loans, mortgages, credit card debts, or other liabilities). Income statements may list income and expenses of a person or family.

Goal setting involves creating a list of financial goals, such as setting an age of retirement, a net worth at retirement, a deadline for purchasing a home, a deadline for paying off a loan, etc. Planning then determines the actions that need to be taken to reach the financial goals. Such actions may include reducing unnecessary expenses, increasing employment income, and reallocation of investments. Once made, the plans are executed, sometimes with assistance from accountants, financial advisors, lawyers, and other professionals. In addition, as the plans are carried out, the person's or family's financial progress is monitored and/or reassessed.

Each of the steps above may be performed with the help of accounting and/or financial planning software. For example, a person may enter in his/her income, expenses, liabilities, and assets into an accounting program. The program may then query the user for a set of financial goals, as well as make recommendations regarding the user's choice of financial goals. The program may also generate one or more plans that enable the user to reach his/her financial goals. Once the user has selected a plan, the program may also monitor his/her progress in carrying out the plan. The program may further reassess the user's financial situation, progress, goals, and plan(s) over time and in light of events that financially impact the user.

To track the person's financial progress, the accounting and/or financial planning software may download the person's financial information from one or more financial institutions. The financial information may include account types, account balances, and/or any financial transactions associated with the respective accounts. Because the financial transactions are stored in a proprietary format by the financial institution, the financial transactions may be difficult to understand and/or categorize. Consequently, the person's financial situation and/or progress may be better assessed by processing financial transaction data and/or obtaining additional information regarding the financial transactions.

### SUMMARY

In general, in one aspect, the invention relates to a method for categorization of transactions, the method including receiving a request for a transaction from a user of a plurality of users, determining an availability of an object association for an object name of an object of the transaction, wherein the object association is a preferred object association of the user, selecting a collaborative object association for the object name when the preferred object association of the user is not available, wherein the collaborative object association is selected based on the preferred object association of the plurality of users for the object name, and providing the collaborative object association to the user.

In general, in one aspect, the invention relates to a computer readable medium including computer program code for categorization of transactions under control of a processor, the computer program code including instructions to receive a request for a transaction from a user of a plurality of users, determine an availability of an object association for an object name of an object of the transaction, wherein the object association is a preferred object association of the user, select a collaborative object association for the object name when the preferred object association of the user is not available, wherein the collaborative object association is selected based on the preferred object association of the plurality of users for the object name, and provide the collaborative object association to the user.

In general, in one aspect, the invention relates to a method for categorization of transactions, the method including obtaining a plurality of preferred object associations for an object name from a plurality of users, wherein the plurality of preferred object associations are provided by the plurality of users responsive to requests by the plurality of users for transactions including an object having the object name, determining a first majority object association from the plurality of preferred object associations based on a number of the plurality of users providing the first majority object association as a preferred object association, receiving a subsequent request for a transaction including the object from a new user, and providing the first majority object association to the new user.

In general, in one aspect, the invention relates to a method for categorization of transactions, the method including requesting a transaction from a transaction management system, receiving an object association for an object name of an object of the transaction, wherein the object association is a collaborative object association for the object name, and wherein the collaborative object association is selected based on a plurality of preferred object associations for the object name of a plurality of users of the transaction management system, and providing a different object association to the transaction management system when the object association is not acceptable.

In general, in one aspect, the invention relates to a transaction management system for categorization of transactions, the transaction management system including a user data repository that includes a plurality of preferred object associations for an object name provided by a plurality of users of the transaction management system, wherein each of the plurality of preferred object associations corresponds to one of the plurality of users, and wherein the plurality of preferred object associations are provided by the plurality of users responsive to requests by the plurality of users for transactions including an object having the object name, a collaborative object repository that includes a plurality of object associations for the object name, wherein each of the plurality of preferred object associations corresponds to one of the plurality of preferred object associations, and a recognition and association system. The recognition and association system is configured to receive a request for a transaction including the object from a user of a plurality of users, determine an availability of a preferred object association corresponding to the user in the user data repository, select a collaborative object association for the object name of the object when the preferred object association corresponding to the user is not available, wherein the collaborative object association is selected based on the plurality of preferred object associations, and provide the collaborative object association to the user.

In general, in one aspect, the invention relates to a data representation for use by a transaction management system to determine a collaborative object association for an object name of an object in a transaction, the data representation including an object association table that includes a plurality of object name and object association pairs, wherein each object name and object association pair corresponds to an object name and object association pair selected by at least one user of a plurality of users of the transaction management system as a preferred object association for the object name of the object, and a user preference table that includes a plurality of mappings of the plurality of users to the plurality of object name and object association pairs in the object association table, wherein each mapping associates a user of the plurality of users with an object name and object association pair in the object association table, and wherein the mapping denotes that the object name and object association pair is a preferred object association of the user for the object name of the object, wherein when the transaction management system receives the object in a transaction responsive to a request for the transaction from a user of the plurality of users, the transaction management system uses the user preference table for determining whether the user has a preferred object association for the object name of the object, and the object association table for choosing an object name and object association pair as a collaborative object association for the object name of the object.

Other aspects of the invention will be apparent from the following description and the appended claims.

### BRIEF DESCRIPTION OF DRAWINGS

FIGS. 1-2 show schematic diagrams in accordance with one or more embodiments of the invention.

FIGS. 3-4 show tracking tables in accordance with one or more embodiments of the invention.

FIGS. 5-8 show flowcharts in accordance with one or more embodiments of the invention.

FIG. 9 shows a computer system in accordance with one or more embodiments of the invention.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

In general, embodiments of the invention provide a method and system to identify associations with object names based on user input. An object (i.e., conceptual entity) may correspond to one or more object name and object association pairs. Object associations may include categories and/or descriptions related to the object name(s). Object names and object associations may initially be obtained from one or more users and stored in an object association table, along with a score representing the level of preference users have shown for the each object name and object association pair (e.g., a count of how many times each pair is chosen by the users as a preferred pair).

A collaborative object association (i.e., a majority object association) may also be determined based on an object name and object association pair most frequently chosen by users (i.e., based on the object name and association pair chosen by a majority of users). The collaborative object association may also be used as a default object name and object association pair for subsequent users associated with the object name. However, the subsequent users may also have an option to provide a preferred object name and object association pair for the object. In addition, the collaborative object association may be changed as preferred object name and object association pairs are provided by subsequent users and the scores for each object name and association pair are updated. Embodiments of the invention may enable quicker identification and confirmation of object names and object associations, thus allowing for more efficient processing and analysis of data.

Specifically, embodiments of the invention may be used to categorize and/or rename payees of financial transactions. The financial transactions may be obtained from one or more financial institutions. The financial transactions may also be associated with one or more users of a financial management system. To rename a payee from a financial transaction, the payee name used by a financial institution may be converted into a normalized payee name using a cleaning algorithm. A user associated with the financial transaction may choose to use the normalized payee name, or the user may provide a preferred payee name as well as a payee category for the financial transaction.

The user's preference for payee name and payee category may be stored in a user preference table. In addition, each unique payee name and payee category pair may be stored in a payee category table, along with a score representing the level of preference users have shown for the unique payee name and payee category pair. A collaborative payee name and payee category may be determined based on the most frequently chosen payee name and payee category pair stored in the payee category table (i.e., based on the payee name and payee category pair chosen by a majority of users). The collaborative payee name and payee category may also change as additional preferred payee names and/or categories are provided by users and the scores are updated. By identifying financial transactions using a collaborative name and payee, embodiments of the invention may allow for quicker payee identification and categorization, as well as a more thorough and accurate assessment of financial progress and/or budget tracking.

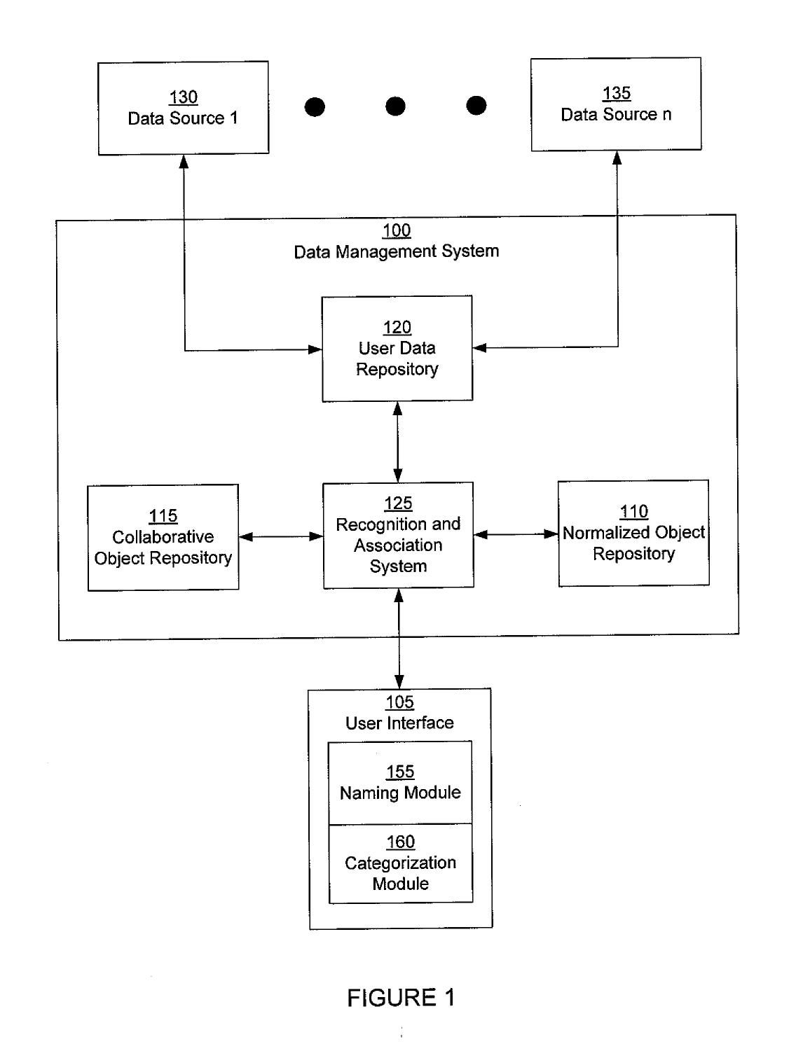

FIG. 1 shows a schematic diagram of a system in accordance with one or more embodiments of the invention. In one or more embodiments of the invention, the system of FIG. 1 is used to identify and store object name and object association pairs for objects. As shown in FIG. 1, the system includes a data management system (100), a user interface (105), and multiple data sources (e.g., data source 1 (130), data source n (135)). Each of these components is described in further detail below.

The data management system (100) may be used to identify and store object name and object association pairs corresponding to objects. Specifically, object names and object associations in the data management system (100) may be used to intelligently analyze and process data in the data management system (100). The object names and object associations may further be used to facilitate human understanding of the data in the data management system (100). Objects may relate to any conceptual entity. For example, object names stored in the data management system (100) may include those of consumer goods, property, natural resources, people, animals, and/or other tangible objects. The data management system (100) may also store object names corresponding to intangible objects such as financial transactions, digital file formats, political preferences, numbers, beliefs, and/or ideas. In one or more embodiments of the invention, object names in the data management system (100) may be stored in one or more databases, such as a relational database, hierarchical database, and/or other type of database.

In one or more embodiments of the invention, the data management system (100) is implemented using a client-server architecture. The data management system (100) itself may be an enterprise application running on one or more servers. In addition, the data management system (100) is accessible using the user interface (105). In one or more embodiments of the invention, the user interface (105) includes a series of web pages that can be reached from a computer with a web browser and internet connection. Alternatively, the user interface (105) is an application that resides on computing systems (e.g., personal computers (PCs), mobile phones, personal digital assistants (PDAs), and other digital computing devices) of users of the data management system (100), and that communicates with the data management system (100) through one or more network connections and protocols.

As mentioned above, an object may be associated with one or more object names. For example, a company may be known by multiple names, including an official company name, a shortened or altered catchphrase or slogan, a company logo, a company trademark, a stock ticker, and/or other representations of the company. An object may also have one or more object associations. In one or more embodiments of the invention, object associations are categories corresponding to an object name. In a broader sense, object associations may correspond to descriptions of the object name. For example, a “house” object may commonly have object associations such as “investment”, “building”, and/or “tax deduction.”

Those skilled in the art will appreciate that a particular object may have multiple object names and/or object associations based on the context in which the object is examined. For example, in an investment context, a supermarket chain may be identified by its stock ticker and include an object association such as “buy”, “sell”, or “hold”, based on forecasts of the supermarket chain's performance. On the other hand, consumers may recognize the same supermarket chain by its trademark name and/or logo and associate the supermarket chain with items sold by the supermarket chain, such as “produce,” “milk,” and/or “snacks.”

In one or more embodiments of the invention, object names and/or object associations in the data management system (100) are obtained from one or more data sources (e.g., data source 1 (130), data source n (135)). The data sources (e.g., data source 1 (130), data source n (135)) may include outside sources of information related to the objects in the data management system (100). For example, if the data management system (100) is used to categorize books, the data sources (e.g., data source 1 (130), data source n (135)) may include book publishers, book retailers, book reviewers, the Library of Congress, and/or other entities with information pertaining to book names and/or categories. One or more object names and/or object associations obtained from the data sources (e.g., data source 1 (130), data source n (135)) may be used to represent the object in the data management system (100). Alternatively, the object may be represented by processing the information from the data sources (e.g., data source 1 (130), data source n (135)) and/or obtaining user input from one or more users of the data management system (100), as explained below.

As shown in FIG. 1, the data management system (100) includes a user data repository (120), a recognition and association system (125), a collaborative object repository (115), and a normalized object repository (110). The user data repository (120) stores object name and object association pairs for users of the data management system (100). In one or more embodiments of the invention, object names and/or object associations obtained from the data sources (e.g., data source 1 (130), data source n (135)) are used as representations of objects for one or more users of the data management system (100). Using the example above, a book categorization system may allow users to find books with specific names and/or categories from multiple data sources (e.g., data source 1 (130), data source n (135)), such as book retailers, book reviewers, book publishers, etc. The book categorizing system may additionally allow users to provide their own names (i.e., nicknames) and/or categories for books in lieu of the names and/or categories provided by the outside sources.

The normalized object repository (110) may store a normalized object name corresponding to one or more object names obtained from the data sources (e.g., data source 1 (130), data source n (135)). In one or more embodiments of the invention, normalized object names are user-friendly names for objects in the data management system (100). For example, if books are stored using their international standard book numbers (ISBNs) by the data sources (e.g., data source 1 (130), data source n (135)), the normalized object repository (110) may store the title and/or author of each book as a normalized object name for the book, since users may be able to identify books by title and/or author more easily than by ISBN. In one or more embodiments of the invention, normalized object names in the normalized object repository (110) are obtained using one or more algorithms. The algorithms may include parsing object names obtained from the data sources (e.g., data source 1 (130), data source n (135)), cross-referencing information found in multiple data sources, and/or other data mining, search, and/or data processing methods.

As described above, object names and object associations obtained from the data sources (e.g., data source 1 (130), data source n (135)) may be associated with one or more users of the data management system (100). Consequently, objects may be represented using the object names and object associations obtained from the data sources (e.g., data source 1 (130), data source n (135)), using normalized object names found in the normalized object repository (110), or using object names and object associations provided by the users. In one or more embodiments of the invention, a default object name and object association pair may be selected from object name and object association pairs obtained from a variety of sources for a particular object. In one or more embodiments of the invention, the default object name and object association pair is selected by determining the object name and object association pair that is chosen most frequently by users (i.e., is chosen by a majority of the users).

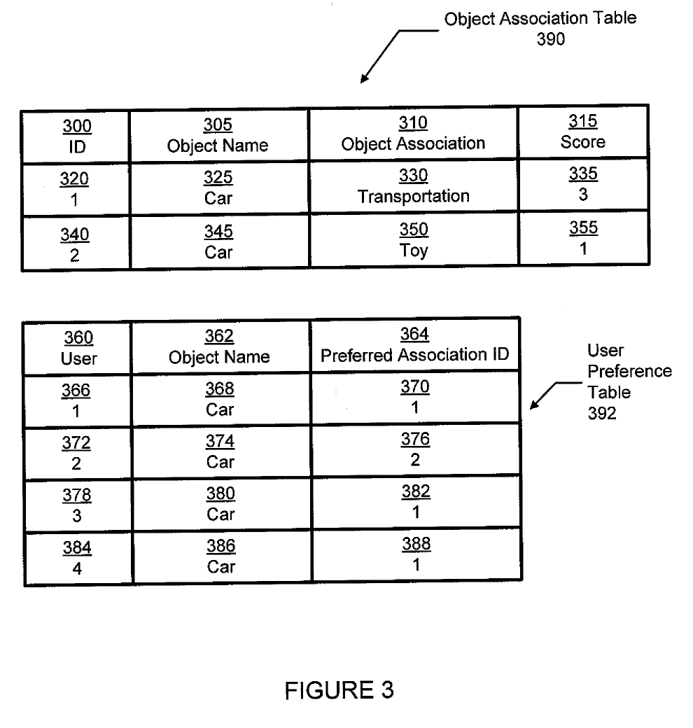

The collaborative object repository (115) stores object names and object associations for each object in the data management system (100). In one or more embodiments of the invention, each entry in the collaborative object repository (115) includes an object name, an object association, and a score. The score represents the level of preference users have shown for the object name in combination with the object association. In one or more embodiments of the invention, the score is a count of the number of times the object name and object association pair is selected by users as a preferred object name and object association pair. Further, in one or more embodiments of the invention, each entry in the collaborative object repository (115) includes a unique object name and object association pair. In one or more embodiments of the invention, each entry may also include the time the entry was last chosen by a user. Entries in the collaborative object repository (115) are explained in further detail with respect to FIG. 3.

The recognition and association system (125) maps object names and object associations to users of the data management system (100). In other words, the recognition and association system (125) determines the representation of an object (i.e., object name and object association pair) that corresponds to a particular user. As described above, the object representation may be selected from object names and object associations from the data sources (e.g., data source 1 (130), data source n (135)) and/or normalized object names in the normalized object repository (110). Additionally, object names and object associations may be obtained from the users.

Specifically, users of the data management system (100) may provide and/or specify preferred object name and object association pairs to represent objects in the data management system (100). The preferred object name and object association pair may be based on the context in which the object is identified by the user. As described above, a supermarket may be known by different names and associations to different users depending on context. An employee of the supermarket may select an “employer” association for the supermarket, a shopper may select a “grocery” association, and a stock broker may select a “hot stock” association.

In one or more embodiments of the invention, users interact with the data management system (100) using the user interface (105), which includes a naming module (155) and a categorization module (160). The naming module (155) allows users to provide and/or select object names for objects in the data management system (100), and the categorization module (160) allows users to provide and/or select object associations for objects in the data management system (100). For example, the user may type in an object name and/or object association for a particular object using the user interface (105). Alternatively, the user may select from object names and/or object associations obtained from the data sources (e.g., data source 1 (130), data source n (135)), the normalized object repository (110), from the user during prior usage of the data management system (100), and/or other users.

In one or more embodiments of the invention, object name and object association pairs provided and/or selected by users are stored as preferred object name and object association pairs for the respective users in the user data repository (120). In other words, objects are represented to each user using the user's preferred object name and object association pairs. As a result, if a user specifies a preferred object name and object association pair for an object, the data management system (100) displays the preferred object name and object association to the user when the object is accessed by the user.

In one or more embodiments of the invention, a user may provide or select more than one object association for an object name of an object. For example, a user employed by a supermarket who also shops at the supermarket may have both an “employer” and a “grocery” association for the supermarket. Each object name and object association pair for an object provided and/or selected by the user is stored as a preferred object name and object association pair for the user in the user data repository (120). In one or more embodiments of the invention, a time the unique object name and object association pair was last chosen by a user may also be stored in the user data repository (120). In such embodiments, when a user accesses an object for which the user has specified more than one object name and object association pair, all of the object name and object association pairs previously specified by the user may be displayed to the user. Further, in one or more embodiments of the invention, the time each object name and object association pair was last chosen by the user may be used to present the pairs in rank order accordingly to the time each pair was last chosen, with the mostly recently chosen pair presented first.

As mentioned above, unique object name and object association pairs may be stored in the collaborative object repository (115) along with scores that represent the level of preference users have shown for the object name and object association pairs. Further, a time each unique object name and object association pair was last chosen by a user may also be stored in the collaborative object repository (115).

The recognition and association system (125) may also determine a collaborative object name and object association from the preferred object names and/or object associations provided by users of the data management system (100). In one or more embodiments of the invention, the collaborative object name and object association is based on the most frequently selected preferred object name and object association pair among users of the data management system (100). In other words, the scores for unique object name and object association pairs in the collaborative object repository (115) are counts of how many times each object name and object association pair has been chosen by users. The scores for unique object name and object association pairs in the collaborative object repository (115) are compared and the preferred object name and object association pair with the highest score is chosen as the collaborative object name and object association. Further, if two or more unique object name and object association pairs have the highest score, the unique object name and object association pair of these tied pairs that was last chosen by a user is chosen as the collaborative object name and object association.

Once the collaborative object name and object association is selected, the collaborative object name and object association may be used as a default object name and object association pair for subsequent users of the data management system (100). For example, if a company has a collaborative association of an “XYZ Co.” object name and a “Consumer Goods” payee category, the data management system (100) displays the collaborative object name and object association as a representation of the company to users with no preferred object name and object association for the company. If a user chooses to alter the company name and/or category, the changes by the user are stored as the user's preferred object name and object association in the user data repository (120) and the preferred object name and object association is displayed to the user in subsequent references to the company.

In one or more embodiments of the invention, the data management system (100) may also provide the collaborative object name and object association to users who have previously specified a preferred object and object association for an object. For example, a user may access the object, whereupon the data management system (100) displays the user's current preferred object name and object association for the object. The user may wish to add or select another object association for the object and may ask the data management system (100) to suggest other options. The data management system (100) may then display one or more other object associations to the user. In one or more embodiments of the invention, the collaborative object name and object association is displayed to the user. In one or more embodiments of the invention, a ranked list of object name and object association pairs provided by other users is displayed to the user with the collaborative object name and object association as the first pair in the list, followed by the other pairs listed in descending order according to the score of each pair. In one or more embodiments of the invention, any previous object associations for the object name provided by the user are displayed prior to the ranked list of the collaborative object name and object association and object name and object association pairs of other users. Further, in one or more embodiments of the invention, the user's previous object associations may be ranked according to the time the user last chose to use the object association for the object name.

The collaborative object name and object association may change as more users provide preferred object names and object associations for an object. For example, in one or more embodiments of the invention, an object may have two unique object name and object association pairs in the collaborative object repository (115). The first object name and object association pair may have a score of 15 and the second object name and object association pair may have a score of 10. However, the next 6 users select the second object name and object association pair as their preferred object name and object association, thus increasing the score for the second object name and object association pair. As a result, the second object name and object association pair has a score of 16 and replaces the first object name and object association pair as the collaborative object name and object association. Further, in one or more embodiments of the invention, when the first object name and object association pair and the second object name and object association pair each have a score of 15, the second object name and object association pair replaces the first object name and object association pair as the collaborative object name and object association because the second pair was selected last by a user.

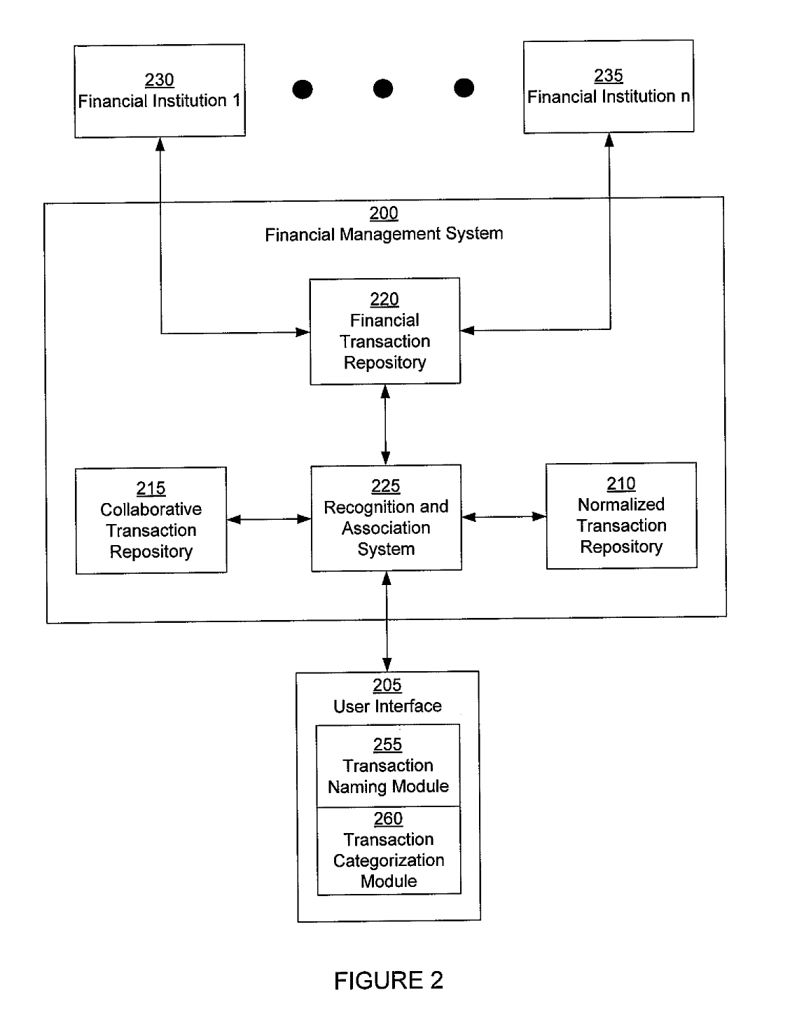

FIG. 2 shows a schematic diagram of a system in accordance with one or more embodiments of the invention. In one or more embodiments of the invention, the system of FIG. 2 is used to categorize and/or rename payees of financial transactions. In other words, the system of FIG. 2 may be an application of the system of FIG. 1 directed to naming and categorizing payees of financial transactions. The system of FIG. 2 includes a financial management system (200), multiple financial institutions (e.g., financial institution 1 (230), financial institution n (235)), and a user interface (205).

The financial management system (200) provides financial services to users through one or more interfaces (e.g., user interface (205)). The interfaces allow the user of the financial services to interact with various components of the financial management system (200) using a user-friendly environment (e.g., a graphical user interface). Further, because of the sensitive nature of financial information, these interfaces are often secure connections employing various known techniques for keeping sensitive information secure. In one or more embodiments of the invention, the financial management system (200) provides accounting services to users of the financial management system (200). For example, the financial management system (200) may provide personal financial planning services, such as financial assessment, budgeting, account tracking, bill payment, and tax preparation services, to users of the financial management system (200). In one or more embodiments of the invention, certain users of the financial management system (200), such as accountants and tax attorneys, may provide accounting services to other users of the financial management system (200).

In one or more embodiments of the invention, the financial management system (200) is implemented using a client-server architecture. The financial management system (200) itself may be an enterprise application running on one or more servers, and in some embodiments could be a peer-to-peer system, or resident upon a single computing system. In addition, the financial management system (200) is accessible using interfaces such as the user interface (205). In one or more embodiments of the invention, the user interface (205) includes one or more web pages that can be reached from a computer with a web browser and/or internet connection. Alternatively, the user interface (205) may be an application that resides on a computing system, which may include personal computers (PCs), mobile phones, personal digital assistants (PDAs), and other digital computing devices of the users, and that communicate with the financial management system (200) through one or more network connections and protocols. Regardless of the architecture of the system, communications between the financial management system (200) and the user interface (205) may be secure, as described above.

The financial management system (200) also includes a financial transaction repository (220), a recognition and association system (225), a normalized transaction repository (210), and a collaborative transaction repository (215) corresponding to the user data repository, recognition and association system, normalized object repository, and collaborative object repository of FIG. 1, respectively. In one or more embodiments of the invention, the various components of the financial management system (200) facilitate the identification and confirmation of a collaborative payee name and payee category for financial transactions stored in the financial management system (200), as explained below.

In one or more embodiments of the invention, the financial management system (200) provides functionality to track and/or manage financial transactions associated with users of the financial management system (200). The financial transactions may be tracked and/or managed to provide financial and/or accounting services and suggestions to the users. The financial transactions may be obtained by the financial management system (200) from one or more financial institutions (e.g., financial institution 1 (230), financial institution n (235)).

Financial institutions (e.g., financial institution 1 (230), financial institution n (235)) may include banks, credit card companies, mortgage companies, investment brokerages, and/or other organizations that participate in financial transactions. Because financial institutions (e.g., financial institution 1 (230), financial institution n (235)) are independent of the financial management system (200), the financial management system (200) may include an interface with each financial institution to exchange information and/or associated funds so that the users may track and/or manage financial transactions and/or accounts with each financial institution.

In one or more embodiments of the invention, financial transactions obtained from the financial institutions (e.g., financial institution 1 (230), financial institution n (235)) are stored in the financial transaction repository (220). Each financial transaction may include, for example, a payee name, transaction date, transaction type, and/or transaction amount. In addition, each financial transaction may be associated with one or more users of the financial management system (200). In other words, a financial transaction may be accessed, managed, and/or viewed by users associated with the financial transaction. In one or more embodiments of the invention, financial transactions are provided by the financial management system (200) to help users assess their financial situations, manage budgets, track financial progress, and/or perform other accounting and finance related tasks.

Those skilled in the art will appreciate that financial transactions may be stored by financial institutions (e.g., financial institution 1 (230), financial institution n (235)) in a proprietary format. Specifically, payee names in financial transactions may include extraneous information, character limits, lack of white space, and/or other qualities that may complicate user recognition of the payee names. In addition, each financial institution (e.g., financial institution 1 (230), financial institution n (235)) may have a different format for storing financial transactions. Further, financial transactions provided by financial institutions (e.g., financial institution 1 (230), financial institution n (235)) may lack categories needed by the users to identify earning, spending, and/or saving habits. As a result, an algorithm-based approach to renaming payees and identifying categories of financial transactions may be difficult to implement.

In one or more embodiments of the invention, a normalized payee name is obtained from a payee name of a financial transaction received by the financial management system (200) from a financial institution (e.g., financial institution 1 (230), financial institution n (235)). In one or more embodiments of the invention, the normalized payee name corresponds to the normalized object name described above with respect to FIG. 1. The normalized payee name may be obtained using one or more algorithms. For example, the payee name string received from the financial institution (e.g., financial institution 1 (230), financial institution n (235)) may be cleaned to remove extraneous information and/or the payee name may be matched against records to identify a recognizable payee name corresponding to the payee name received from the financial institution. Normalized payee names may be stored in the normalized transaction repository (210) and retrieved when financial transactions associated with the normalized payee names are accessed by users of the financial management system (200).

In one or more embodiments of the invention, the normalized payee name may be presented to the user when the user initially accesses the financial transaction. In one or more embodiments of the invention, the normalized payee name may not be uniquely user-recognizable. In such embodiments, the original payee name from the financial transaction may be presented to the user rather than the normalized payee name. The user may choose to keep the normalized payee name (or the original payee name) with respect the financial transaction, or the user may select and/or provide a preferred payee name in place of the normalized payee name.

The user may also select and/or provide a payee category associated with the financial transaction for storage in the financial management system (200). In one or more embodiments of the invention, user preferences for payee names and/or payee categories are stored in the financial transaction repository (220). Further, in one or more embodiments of the invention, the user may select and/or provide a different payee category for the preferred payee name when the user access subsequent financial transactions having the same payee. Each user preference for payee name and payee category for the payee is stored in the financial transaction repository (220). In one or more embodiments of the invention, a time each payee name and payee category was last chosen by the user for a financial transaction is also recorded in the financial transaction repository (220). This time may be used as in a similar fashion as described above in relation to FIG. 1.

In addition, each unique payee name and payee category pair provided by users of the financial management system (200) may be stored in the collaborative transaction repository (215). The collaborative transaction repository (215) may also include a score representing the level of preference users have shown for each unique payee name and payee category pair. In one or more embodiments of the invention, the score is a count of the number of times each unique payee name and payee category pair is selected by the users. The scores may further be used to determine a collaborative payee name and payee category for subsequent transactions related to a particular normalized payee name. Further, in one or more embodiments of the invention, a time each unique payee name and payee category pair was last chosen by a user may be stored in the collaborative transaction repository (215) and may be used as a tie breaker in determining the collaborative payee name and payee category.

In one or more embodiments of the invention, the collaborative payee name and payee category is selected by the recognition and association system (225) based on a payee name and payee category pair with the highest score in the collaborative transaction repository (215). For example, three unique payee name and payee category pairs corresponding to a normalized payee name may be stored in the collaborative transaction repository (215). Further, the scores for the three unique payee name and payee category pairs are counts of the number of times users have selected the pairs as preferred payee name and payee category pairs. The first payee name and payee category pair has a score of 5, the second payee name and payee category pair has a score of 23, and the third payee name and payee category pair has a score of 24. Because a majority of users has selected the third payee name and payee category pair, the third payee name and payee category pair is set as the collaborative payee name and payee category. Further, if the second payee name and payee category pair and the third payee name and payee category pair each has a score of 23, and the second payee name and payee category pair was last chosen by a user as the user's preferred payee name and payee category pair, the second payee name and payee category pair is set as the collaborative payee name and payee category.

The collaborative payee name and payee category may be used as a default payee name and payee category for subsequent financial transactions associated with the normalized payee name. Users may choose to select and/or provide a different payee name and/or payee category from the default payee name and payee category. Further, the changes may be saved by the recognition and association system (225) as the user(s) preferred payee name and payee category in the financial transaction repository (220). As described above with respect to FIG. 1, the collaborative payee name and payee category may change as other payee name and payee category pairs are selected by users. Further, as described above with respect to FIG. 1, in one or more embodiments of the invention, the collaborative payee name and payee category may be presented to a user already having one or more preferred payee name and payee category pairs for a payee.

In one or more embodiments of the invention, a user may assign tax categories to the user's payee categories. In one or more embodiments of the invention, the tax categories that the user may assign are predetermined based on categories of financial data used in tax forms. For example, real estate taxes and mortgage interest for a family home may be included on Schedule A of a user's income tax return. Thus, two of the predetermined tax categories may be “real estate tax” and “mortgage interest.” In one or more embodiments, the financial management system (200) may suggest a tax category for a payee name and payee category pair based on a tax category for the pair previously selected by other users. In one or more embodiments of the invention, a user may select the tax category from a list of tax categories provided by the financial management system (200). Further, in one or more embodiments of the invention, the tax categories chosen by the user for the user's payee categories may be used to automatically recognize tax deductions for the user.

FIG. 3 shows a set of tracking tables in accordance with one or more embodiments of the invention. Specifically, FIG. 3 shows an object association table (390) that includes fields for an identifier (ID) (300), object name (305), object association (310), and score (315), as well as a user preference table (392) containing fields for a user (360), an object name (362), and a preferred association ID (364). In one or more embodiments of the invention, the object association table (390) is stored in the collaborative object repository of FIG. 1, and the user preference table (392) is stored in the user data repository of FIG. 1. Data in the two tables may be used by the recognition and association system of FIG. 1 to track preferred object names and object associations for multiple users, as well as to determine a collaborative object name and object association based on the preferred object names and object associations of the users.

Further, while only one unique object name (305, 362) with multiple object associations (310) is illustrated in FIG. 3 for simplicity of explanation, one of ordinary skill in the art will understand that in one or more embodiments of the invention, the object association table (390) and user preference table (392) may have entries for multiple unique object names, each of which may have one or more object associations. In addition, one or more embodiments of the invention may have a distinct object association table (390) and user preference table (392) for each unique object name (305, 362). Furthermore, in one or more embodiments of the invention, the object association table (390) and user preference table (392) may be combined. Accordingly, the specific arrangement of the tables shown in FIG. 3 should not be construed as limiting the scope of the invention.

As shown in FIG. 3, unique object name and object association pairs are assigned an ID (300). In addition, an object name (305) and association (310) are listed for each unique object name and object association pair. The object association table (390) of FIG. 3 shows two unique object name and object association pairs for a car object. The first entry lists an ID (300) of 1 (320) corresponding to an object name (305) of car (325) and an object association (310) of transportation (330). The second entry lists an ID (300) of 2 (340), which corresponds to an object name (305) of car (345) and an object association (310) of toy (350). In one or more embodiments of the invention, each entry in the object association table (390) may be identified using the ID (300). Alternatively, each entry may be identified using the object name (305) and object association (310).

User preferences for object name and object association pairs are stored in the user preference table (392) and reference the IDs in the object association table (390). As shown in FIG. 3, the user preference table (392) includes four users (360) denoted by the numbers 1 (366), 2 (372), 3 (378), and 4 (384). Each user (360) has a preference for the car object; thus the entry for each user includes an object name (362) of car (368, 374, 386, 386). Users 1 (366), 3 (378), and 4 (384) have a preferred association ID (364) of 1 (370, 382, 388) and user 2 (372) has a preferred association ID (362) of 2 (376). In one or more embodiments of the invention, the preferred association ID (362) refers to the ID (300) of the entry stored in the object association table (390) that is preferred by the user (360). In other words, users 1 (366), 3 (378), and 4 (384) prefer the association of car (325) with transportation (330), and user 2 (372) prefers the association of car (345) with toy (350).

In addition, the score (315) field of the object association table (390) tracks the overall preferences of the users in the user preference table (392). As shown in FIG. 3, the score (315) is a count of the number of times users have selected the object name and object association corresponding the score (315) field as a preferred object name and object association. The object name and object association pair with an ID (300) of 1 (320) contains a score (315) of 3 (335), reflecting the preferences of users 1 (366), 3 (378), and 4 (384). Similarly, the object name and object association pair with an ID (300) of 2 (340) contains a score (315) of 1 (355) corresponding to the preference of user 2 (372). Based on the scores, the object name and object association pair with an ID (300) of 1 (320) may be selected as the collaborative object name and object association pair.

Further, in one or more embodiments of the invention, the object association table (390) may be ordered according to the scores such that the entry containing the collaborative object name and object association pair is the first (or last) entry in the object association table (390). More specifically, the entries in the object association table (390) may be arranged in descending (or ascending order) based on the score (315) of how many times the object name and object association in each entry is selected as a user preferred object name and object association by distinct users. For example, if three additional users subsequently select the object name and object association pair with an ID (300) of 2 (340) as their preferred object name and object association pair, the score (315) is increased to 4. The entries in the object association table (390) may subsequently be reordered such that the entry corresponding to the object name and association pair with an ID (300) of 2 (340) is placed higher (or lower) than the entry corresponding to the object name and association pair with an ID (300) of 1 (320).

Furthermore, in one or more embodiments of the invention, if two or more entries in the object association table (390) have the same score (315), a time that the object name and object association of an entry was last selected as a user preferred object name and object association is used to break the tie, with entries with later selection times placed higher (or lower) in the object association table (390) than the entries with earlier selection times. For example, if two additional users subsequently select the object name and object association pair with an ID (300) of 2 (340) as their preferred object name and object association pair, the score (315) is increased to 3. The entries in the object association table (390) may subsequently be reordered and a determination will be made that the entry corresponding to the ID (300) of 1 (320) and the entry corresponding to the ID (300) of 2 (340) have the same score (315). The time that the object name and object association of each entry was last selected as a preferred object name and object association by a user is then used to select the most recently chosen object name and object association among the two entries. Thus, the entry corresponding to the object name and association pair with an ID (300) of 2 (340) is placed higher (or lower) than the entry corresponding to the object name and association pair with an ID (300) of 1 (320).

In one or more embodiments of the invention, new entries may be added to the object association table (390) and user preference table (392) and/or the order of the entries in the object association table (390) may be changed as needed each time a user chooses to create a new object name and object association or each time a user selects a pre-existing object name and object association as a preferred object name and object association thus affecting a score (315). Further, in one or more embodiments of the invention, new entries may be added to the tables (390, 392) and/or the order of the entries in the object association table (390) may be changed when a user logs out of the data management system (100).

In such embodiments, a history of the user's transactions with the data management system (100) may be used to determine the user's changes and/or additions to object name/object association pairings in order to update the tables (390, 392) and reorder the object association table (390) as needed. In addition, in one or more embodiments of the invention, the object association table (390) and the user preference table (392) maybe be updated periodically using a batch process that iterates through the transactions of all users with the data management system (100) since the last batch run to determine changes and/or additions to object name/object association pairings made by all users in order to update the tables (390, 392) and reorder the object association table (390) as needed.

In one or more embodiments of the invention, the user preference table (392) may include an object association field in each entry and the preferred association id (364) field may be eliminated. One of ordinary skill in the relevant art will recognize that such a configuration of the user preference table may provide a performance improvement over the configuration shown in FIG. 3, particularly in locating a particular user's preferred object name and object association pairs.

In one or more embodiments of the invention, the user preference table (392) may include a timestamp field for each entry. The timestamp for each entry records the last time an entry was used by the user. As previously explained, a user may have more than one object association for an object name. The timestamps for the user's object name and object association pairs that share the same object name may be used to rank the pairs for presentation to the user, with the pairs presented in descending order according to the timestamps. Further, in one or more embodiments of the invention, when the user accesses the object, the data management system (100) may select the object name and object association for the object to be displayed to the user from amongst the user's object name and object association pairs for the object based on the timestamps. More specifically, the data management system (100) selects the object name and object association pair with the most recent timestamp for display.

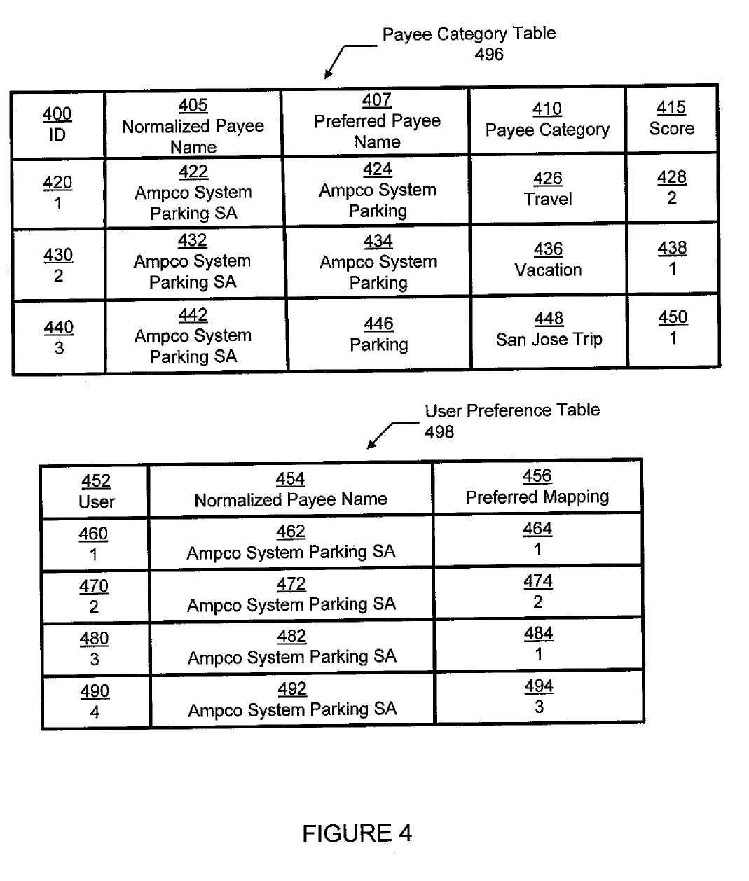

FIG. 4 shows a set of tracking tables in accordance with one or more embodiments of the invention. Specifically, FIG. 4 shows a payee category table (496) that includes fields for an ID (400), a normalized payee name (405), a preferred payee name (407), a payee category (410), and a score (415), as well as a user preference table (498) containing fields for a user (452), a normalized payee name (454), and a preferred mapping (456). In one or more embodiments of the invention, the payee category table (496) is stored in the collaborative transaction repository of FIG. 2, and the user preference table (498) is stored in the financial transaction repository of FIG. 2. Data in the two tables may be used by the recognition and association system of FIG. 2 to track preferred payee names and payee categories for multiple users, as well as to determine a collaborative payee name and payee category based on the preferred payee names and payee categories of the users.

Further, while only one unique normalized payee name (405, 454) with multiple preferred payee names (407) and payee categories (410) is shown in FIG. 4 for simplicity of explanation, one of ordinary skill in the art will understand that in one or more embodiments of the invention, the payee category table (496) and user preference table (498) may have entries for multiple unique normalized payee names, each of which may have one or more preferred payee names and/or payee categories. In addition, one or more embodiments of the invention may have a distinct payee category table (496) and user preference table (498) for each unique normalized payee name (305, 362). Furthermore, in one or more embodiments of the invention, the payee category table (496) and user preference table (498) may be combined. Accordingly, the specific arrangement of the tables shown in FIG. 4 should not be construed as limiting the scope of the invention.

As shown in FIG. 4, unique payee name and payee category pairs corresponding to a normalized payee name (405) are assigned an ID (400). In addition, a preferred payee name (407) and category (410) is listed for each unique payee name and category pair. The payee category table (496) of FIG. 4 shows three unique payee name and payee category pairs for a normalized payee name (405) of Ampco System Parking SA (422, 432, 442). The first entry lists an ID (400) of 1 (420) corresponding to a preferred payee name (407) of Ampco System Parking (424) and a payee category (410) of Travel (426). The second entry lists an ID (400) of 2 (430), which corresponds to a preferred payee name (407) of Ampco System Parking (434) and a payee category (410) of Vacation (436). The third entry lists an ID (400) of 3 (350) corresponding to a preferred payee name (407) of Parking (446) and a payee category (410) of San Jose Trip (448). In one or more embodiments of the invention, each entry in the payee category table (496) may be identified using the ID (400). Alternatively, each entry may be identified using the preferred payee name (407) and payee category (410).

User preferences for payee name and payee category pairs are stored in the user preference table (498) and reference the IDs in the payee category table (496). As shown in FIG. 4, the user preference table (498) includes four users (452) denoted by the numbers 1 (460), 2 (470), 3 (480), and 4 (490). Each user (452) has a preference for the normalized payee name (454) of Ampco System Parking SA (462, 472, 482, 492). Users 1 (460) and 3 (480) have a preferred mapping (456) of 1 (464, 484), user 2 (470) has a preferred mapping (456) of 2 (474), and user 4 (490) has a preferred mapping (456) of 3 (494). In one or more embodiments of the invention, the preferred mapping (456) is the entry in the payee category table that is preferred by the user (452). In other words, users 1 (460) and 3 (480) prefer the association of Ampco System Parking (424) with Travel (426), user 2 (470) prefers the association of Ampco System Parking (434) with Vacation (436), and user 4 (490) prefers the association of Parking (446) with San Jose Trip (448).

In addition, the score (415) field of the payee category table (496) tracks the overall preferences of the users in the user preference table (498). As shown in FIG. 4, the score (415) is a count of the number of times users have selected the payee name and payee category corresponding the score (415) field as a preferred payee name and payee category. The payee name and payee category pair with an ID (400) of 1 (420) contains a score (415) of 2 (428), reflecting the preferences of users 1 (460) and 3 (480). Similarly, the payee name and payee category pair with an ID (400) of 2 (430) contains a score (415) of 1 (438) corresponding to the preference of user 2 (470). Finally, the payee name and payee category pair with an ID (400) of 3 (440) shows a score (415) of 1 (450) corresponding to the preference of user 4 (490). Based on the scores, the payee name and payee category pair with an ID (400) of 1 (420) may be selected as the collaborative payee name and payee category for the normalized payee name (405) of Ampco System Parking SA (422, 432, 442).

Further, in one or more embodiments of the invention, the payee category table (496) may be ordered according to the number of times the users have selected each preferred payee name and payee category pair as a preferred payee name and payee category pair such that the entry containing the collaborative payee name and payee category pair is the first (or last) entry in the payee category table (496). More specifically, the entries in the payee category table (496) may be arranged in descending (or ascending order) based on the score (415). For example, if two additional users subsequently select the payee name and payee category pair with an ID (400) of 2 (430) as their preferred payee name and payee category pair, the score (415) is increased to 3. The entries in the payee category table (496) may subsequently be reordered such that the entry corresponding to the payee name and payee category pair with an ID (400) of 2 (430) is placed higher (or lower) than the entry corresponding to the payee name and payee category pair with an ID (400) of 1 (420).

In one or more embodiments of the invention, if two or more entries in the payee category table (496) have the same score (415), a time that the payee name and payee category of an entry was last selected as a user preferred payee name and payee category is used to break the tie, with entries with later selection times placed higher (or lower) in the payee category table (496) than the entries with earlier selection times. For example, if one additional user subsequently selects the payee name and payee category pair with an ID (400) of 2 (340) as the user's preferred payee name and payee category pair, the score (415) is increased to 2. The entries in the payee category table (496) may subsequently be reordered and a determination is made that the entry corresponding to the ID (400) of 1 (420) and the entry corresponding to the ID (400) of 2 (430) have the same score (415). The time that the payee name and payee category of each entry was last selected as a preferred payee name and payee category by a user is then used to select the most recently chosen payee name and payee category among the two entries. Thus, the entry corresponding to the payee name and association pair with an ID (400) of 2 (430) is placed higher (or lower) the entry corresponding to the payee name and association pair with an ID (400) of 1 (420).

In one or more embodiments of the invention, new entries may be added to the payee category table (496) and user preference table (498) and/or the order of the entries in the payee category table (496) may be changed as needed each time a user chooses to create a new payee name and/or payee category or each time a user selects a pre-existing payee name and payee category as a preferred payee name and payee category thus affecting a score (415). Further, in one or more embodiments of the invention, new entries may be added to the tables (496, 498) and/or the order of the entries in the payee category table (496) may be changed when a user logs out of the financial management system (200).

In such embodiments, a history of the user's transactions with the financial management system (200) may be used to determine the user's changes and/or additions to payee name/payee category pairings in order to update the tables (496, 498) and reorder the payee category table (496) as needed. In addition, in one or more embodiments of the invention, the payee category table (496) and the user preference table (498) maybe be updated periodically using a batch process that iterates through the transactions of all users with the financial management system (200) since the last batch run to determine changes and/or additions to payee name/payee category pairings made by all users in order to update the tables (496, 498) and reorder the payee category table (496), as needed.

In one or more embodiments of the invention, the user preference table (498) may include a preferred payee name field and payee category field in each entry and the preferred mapping (456) field may be eliminated. One of ordinary skill in the relevant art will recognize that such a configuration of the user preference table may provide a performance improvement over the configuration shown in FIG. 3, particularly in locating a particular user's preferred payee name and payee category pairs.

In one or more embodiments of the invention, the user preference table (498) may include a timestamp field for each entry. The timestamp for each entry records the last time an entry was used by the user. As previously explained, a user may have more than preferred payee name and/or payee category for a normalized payee name. The timestamps for the user's preferred payee name and payee category pairs that share the same preferred payee name may be used to rank the pairs for presentation to the user, with the pairs presented in descending order according to the timestamps. Further, in one or more embodiments of the invention, when the user accesses a financial transaction, the financial management system (200) may select the preferred payee name and payee category for the payee in the financial transaction that is to be displayed to the user from amongst the user's preferred payee name and payee category pairs for the normalized payee name based on the timestamps. More specifically, the financial management system (200) selects the preferred payee name and payee category pair with the most recent timestamp for display.

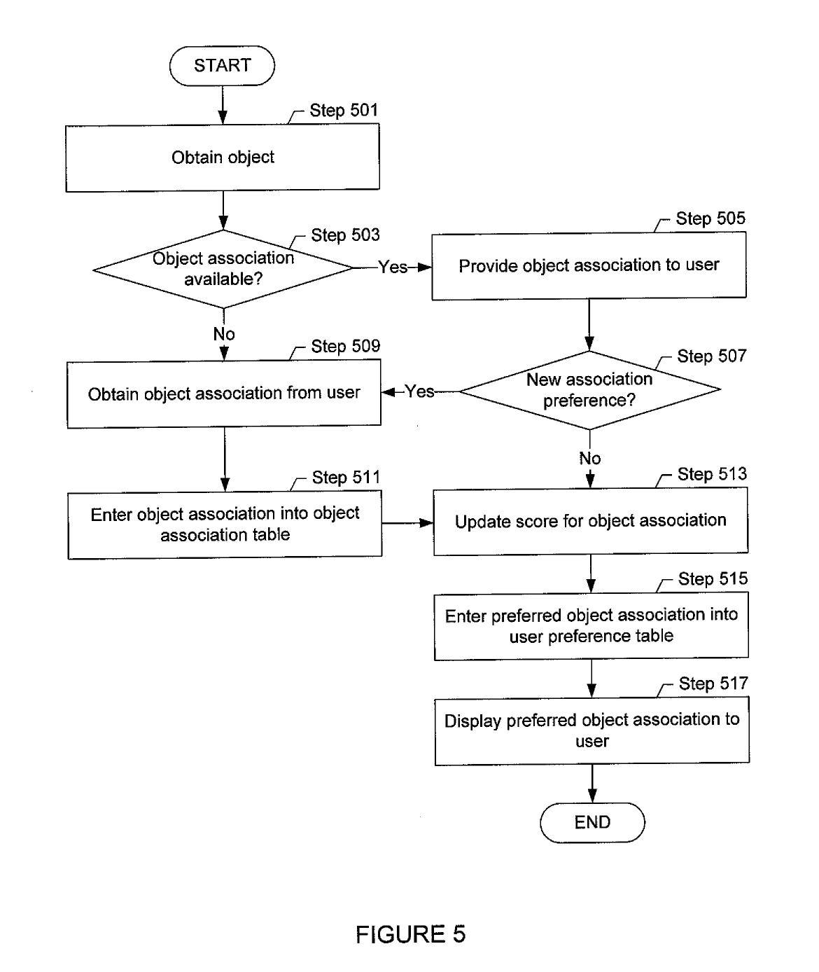

FIG. 5 shows a flow diagram for determining an object name and association for a user in accordance with one or more embodiments of the invention. In one or more embodiments of the invention, one or more of the steps described below may be omitted, repeated, performed concurrently with other steps, and/or performed in a different order. Accordingly, the specific arrangement of steps shown in FIG. 5 should not be construed as limiting the scope of the invention.

Initially, an object containing data is obtained (Step 501). Further, the object may be obtained from a data source, such as the data sources of FIG. 1. A determination is made regarding an availability of an object association (i.e., object name and object association pair) for the object name of the object (Step 503). The object association may be provided by the data sources, by processing information from the data sources to obtain a normalized object name, or by obtaining the object association from other users. In one or more embodiments of the invention, to determine the availability of an object association for the object name, the user preference table is checked for an object name and object association pair previously specified for the object by the user. If no entry in the user preference table is found, thus indicating that the user has not previously specified an object name and object association pair for the object, the object association table is checked for a collaborative object association for the object name.

If an object association is not available for the object name, a new object association is obtained from the user (Step 509) and stored in the object association table (Step 511). If an object association is available for the object name, the object association is provided to the user (Step 505). As stated above, the object association provided to the user may be an object association for the object name previously specified by the user or a collaborative association.

The user may choose the object association provided, or the user may prefer a new object association (Step 507). If a new object association is preferred, the user provides the object association (Step 509). In one or more embodiments of the invention, the user may enter an object association or may select an object association from a list of suggested object associations presented to the user. As previously explained, the user may have more than one object association for the object name in the user preference table. In one or more embodiments of the invention, all of the user's object associations for the object name may be provided as suggestions to the user. Further, in one or more embodiments of the invention, the user's object associations may be ranked for presentation according to the time each object association was last chosen by the user.

In one or more embodiments of the invention, the list of suggested object associations may include a ranked ordering of the user's object associations and the object associations for the object name in the object association table. More specifically, the list of suggested object associations may include the user's object associations ranked according the time each was last chosen by the user followed by object associations from the object association table ranked by score. In one or more embodiments, the number of suggested object associations in the list presented to the user may be limited to a predetermined number.

In one or more embodiments of the invention, the score of an entry in the object association table also indicates the validity of the entry, i.e., how likely it is that another user may want to use the object name and object association defined in the entry. The score of an entry may be used to determine whether an entry in the object association table may be presented to any user other than the user who originally defined the object name and object association in the entry. The lower the score, the lesser the validity of the entry. If the entry has a score below a predetermined score threshold, the entry is not presented to any user other than the user who originally defined the object name and object association in the entry. Thus, any object association for the object name in the object association table having a score below the predetermined score threshold is not included in the list presented to the user.

The object association provided by the user may then be stored in the object association table (Step 511). Regardless of the user's association preference, the score for the object association selected by the user is updated (Step 513). As stated above, the score may also be stored in the object association table. Further, the score may be used to determine the collaborative association for the object. The user's preferred object association may also entered into the user preference table (Step 515), as shown in FIG. 3, and the user's preferred object association is displayed to the user (Step 517).

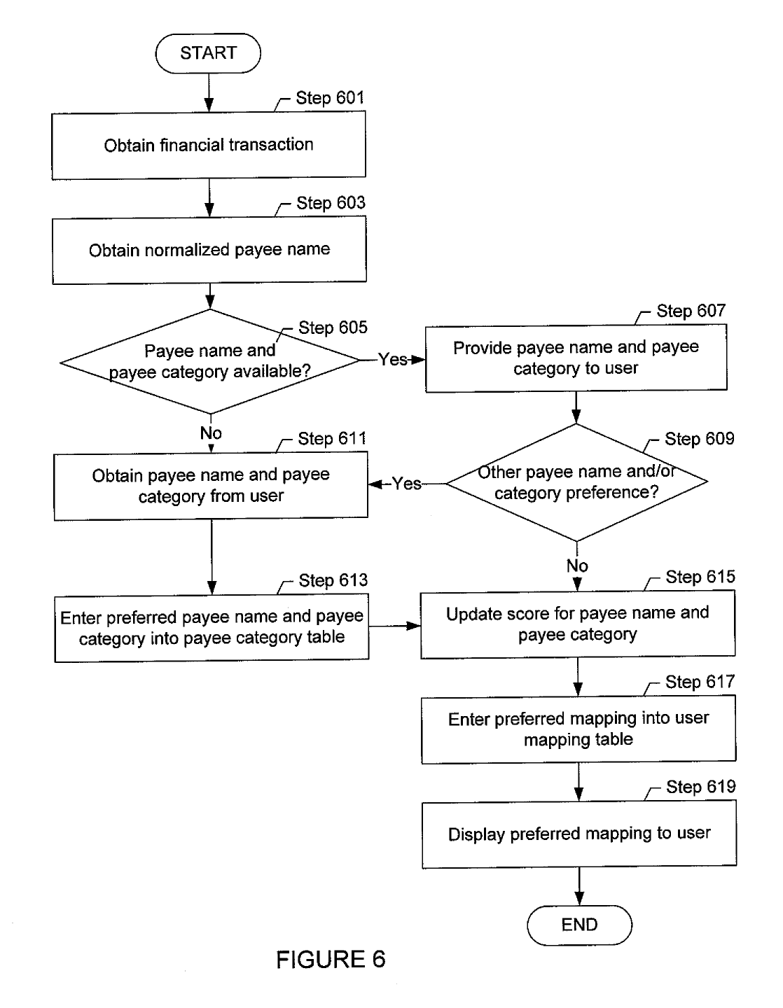

FIG. 6 shows a flow diagram for determining a preferred payee name and payee category for a user in accordance with one or more embodiments of the invention. In one or more embodiments of the invention, one or more of the steps described below may be omitted, repeated, performed concurrently with other steps, and/or performed in a different order. Accordingly, the specific arrangement of steps shown in FIG. 6 should not be construed as limiting the scope of the invention.

Initially, a financial transaction is obtained (Step 601). The financial transaction may be obtained from a financial institution, such as a bank, credit card company, brokerage, etc. A normalized payee name is obtained from the financial transaction (Step 603). As mentioned above, the normalized payee name may be obtained by processing the financial transaction, referencing the financial transaction with other sources, and/or performing other algorithmic steps.

A determination is made regarding the availability of a payee name and payee category for the normalized payee name (Step 605). In one or more embodiments of the invention, to determine the availability of a payee name and payee category for the normalized payee name, the user preference table is checked for a payee name and payee category pair previously specified for the normalized payee name by the user. If no entry in the user preference table is found, thus indicating that the user has not previously specified a payee name and payee category for the normalized payee name, the payee category table is checked for a collaborative payee name and payee category for the normalized payee name.

If a payee name and payee category is not available, a payee name and payee category is obtained from the user (Step 611) and stored in the payee category table (Step 613). If a payee name and payee category is available, the payee name and payee category is presented to the user (Step 607). As stated above, the payee name and payee category presented to the user may be a payee name and payee category previously specified by the user or a collaborative payee name and payee category.

The user may select the payee name and payee category presented, or the user may choose to provide a different payee name and payee category (Step 609). If the user chooses to provide a different payee name and payee category, the payee name and payee category is obtained from the user (Step 611). In one or more embodiments of the invention, the user may enter a new payee name and payee category or may select payee name and payee category pair from a list of suggested payee name and payee category pairs presented to the user. As previously explained, the user may have more than one payee name and payee category pair for the normalized payee name in the user preference table. In one or more embodiments of the invention, all of the user's payee name and payee category pairs for the normalized payee name may be provided as suggestions to the user. Further, in one or more embodiments of the invention, the user's payee name and payee category pairs may be ranked for presentation according to the time each payee name and payee category pair was last chosen by the user.

In one or more embodiments of the invention, the list of suggested payee name and payee category pairs may include a ranked ordering of the user's payee name and payee category pairs and payee name and payee category pairs for the normalized payee name in the payee category table. More specifically, the list of suggested payee name and payee category pairs may include the user's payee name and payee category pairs ranked according the time each was last chosen by the user followed by payee name and payee category pairs from the payee category table ranked by score. In one or more embodiments, the number of suggested payee name and payee category pairs in the list presented to the user may be limited to a predetermined number.

In one or more embodiments of the invention, the score of an entry in the payee category table also indicates the validity of the entry, i.e., how likely it is that another user may want to use the payee name and payee category defined in the entry. The score of an entry may be used to determine whether a payee name and payee category pair in the payee category table may be presented to any user other than the user who originally defined the payee name and payee category pair. The lower the score, the lesser the validity of the payee name and payee category pair. If the payee name and payee category pair has a score below a predetermined score threshold, the payee name and payee category pair is not presented to any user other than the user who originally defined the payee name and payee category pair. Thus, any payee name and payee category pair for the normalized payee name in the payee category table having a score below the predetermined score threshold is not included in the list presented to the user.

The payee name and payee category provided by the user may be entered into the payee category table (Step 613). Regardless of the user's preference for a new or existing payee name and payee category, the score is updated for the payee name and payee category selected and/or provided by the user (Step 615). As mentioned previously, the score may be used to determine a collaborative payee name and payee category for the normalized payee name. The preferred mapping of the user to the payee name and payee category selected by the user may also be entered into the user preference table (Step 617), as shown in FIG. 4. Finally, the preferred mapping is displayed to the user (Step 619).

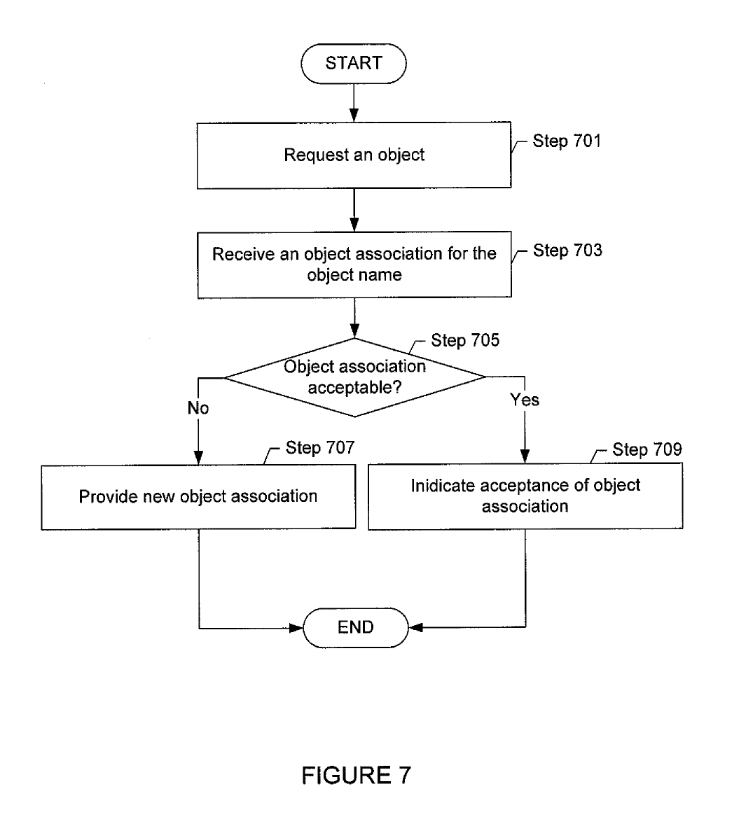

FIG. 7 shows a flow diagram for selecting an object association from the perspective of the user in accordance with one or more embodiments of the invention. In one or more embodiments of the invention, one or more of the steps described below may be omitted, repeated, performed concurrently with other steps, and/or performed in a different order. Accordingly, the specific arrangement of steps shown in FIG. 7 should not be construed as limiting the scope of the invention.

Initially, a user (using some form of an interface) initiates a transaction to a data management system requesting an object (Step 701). The user then receives an object association for the object name corresponding to the object from the data management system (via the interface) (Step 703). The object association may be the user's preferred object association as selected during a previous transaction or may be a collaborative object association if the user has no preferred object association. If the user determines that the object association is acceptable (Step 705), the user then indicates acceptance of the object association to the data management system (Step 709).

As previously explained, if the accepted object association is the user's previously specified preferred object association, the data management system does not need to make any changes to the object association table or the user preference table. If the accepted object association is the collaborative object association and the user had no previously specified preferred object association, the data management system updates the score for the object association in the object association table and adds the user's preference indication to the user preference table. Furthermore, if the accepted object association is the collaborative object association and the user had a previously specified preferred object association, the data management system updates the score for the object association in the object association table and the user's preference indication in the user preference table.

If the user determines that the object association is not acceptable (Step 705), the user then uses the user interface to provide a new object association to the data management system (Step 707). In one or more embodiments of the invention, the user may receive a list of object associations for the object name from the data management system and select an object association from the list and/or may specify a new object association. If the user selects an already known object association, the data management system updates the score of the object association in the object association table and updates the user preference table, as needed. If the user specifies a new object association, the data management system adds the new object association to the object association table and updates the user preference table as needed. In one or more embodiments of the invention, the new object association is added to the object association table only if the user has not previously specified a new object association for the object name. That is, a user may only cause one new object association for the object name to be added to the object association table.

Although not specifically shown in FIG. 7, if no object association is available for the object name of the object requested by the user, the user is asked to provide an object association. The data management system then adds the new object association to the object association table and the new user preference to the user preference table. Furthermore, the object association becomes the collaborative object association for the object name as the object association is the only object association available for the object name.

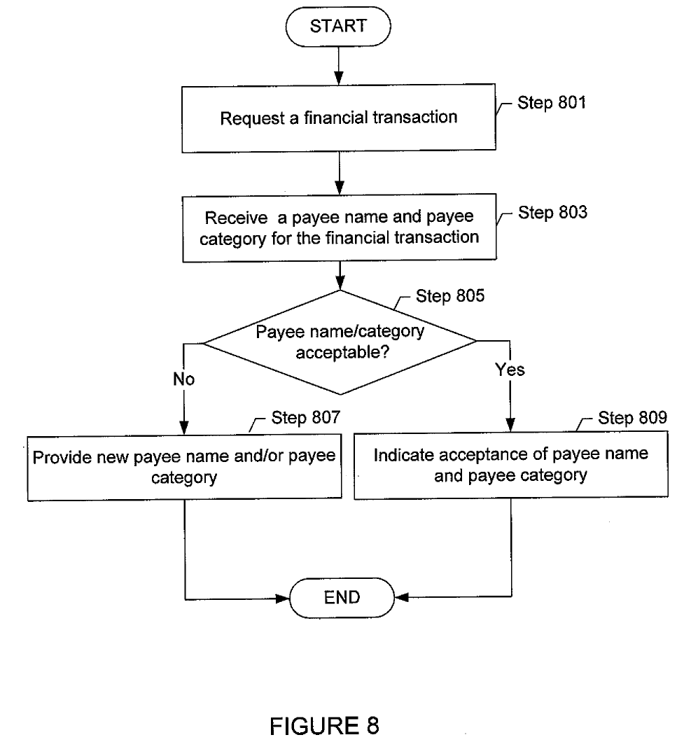

FIG. 8 shows a flow diagram for selecting a payee name and payee category from the perspective of the user in accordance with one or more embodiments of the invention. In one or more embodiments of the invention, one or more of the steps described below may be omitted, repeated, performed concurrently with other steps, and/or performed in a different order. Accordingly, the specific arrangement of steps shown in FIG. 8 should not be construed as limiting the scope of the invention.

Initially, a user (using some form of an interface) requests a financial transaction from a financial management system (Step 801). The user then receives from the financial management system (via the interface) a payee name and payee category corresponding to the normalized payee name of the financial transaction (Step 803). The payee name and payee category may be the user's preferred payee name and payee category as selected during a previous transaction or may be a collaborative payee name and payee category if the user has no preferred payee name and payee category. If the user determines that the payee name and payee category is acceptable (Step 805), the user then indicates acceptance of the payee name and payee category to the data management system (Step 809).

As previously explained, if the accepted payee name and payee category is the user's previously specified preferred payee name and payee category, the financial management system does not need to make any changes to the payee category table or the user preference table. If the accepted payee name and payee category is the collaborative payee name and payee category and the user had no previously specified preferred payee name and payee category, the financial management system updates the score for the payee name and payee category in the payee category table and adds the user's preference indication to the user preference table. Furthermore, if the accepted payee name and payee category is the collaborative payee name and payee category, and the user had a previously specified preferred payee name and payee category, the financial management system updates the score for the payee name and payee category in the payee category table and changes the user's preference indication in the user preference table.

If the user determines that the payee name and payee category is not acceptable (Step 805), the user then uses the interface to provide a new payee name and payee category to the financial management system (Step 807). In one or more embodiments of the invention, the user may receive a list of payee name and payee categories for the normalized payee name from the financial management system and select a payee name and payee category from the list and/or may specify a new payee name and payee category. If the user selects an already known payee name and payee category, the data management system updates the score of the payee name and payee category in the payee category table and updates the user preference table as needed. If the user specifies a new payee name and payee category, the data management system adds the new payee name and payee category to the payee category table and updates the user preference table as needed. In one or more embodiments of the invention, the new payee name and payee category is added to the payee category table only if the user has not previously specified a new payee name and payee category for the normalized payee name. That is, a user may only cause one new payee name and payee category for the normalized payee name to be added to the payee category table.

Although not specifically shown in FIG. 8, if no payee name and payee category is available for the normalized payee name of the financial transaction requested by the user, the user is asked to provide a payee name and payee category. The financial management system then adds the new payee name and payee category to the payee name and payee category table and the new user preference to the user preference table. Furthermore, the payee name and payee category becomes the collaborative payee name and payee category for the normalized payee name as the payee name and payee category is the only payee name and payee category available for the normalized payee name.

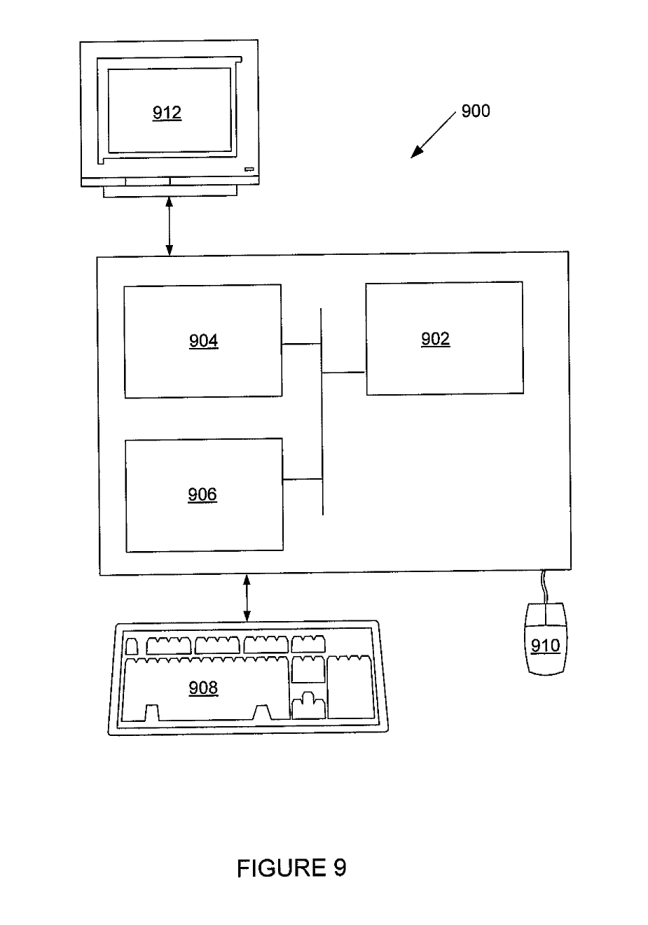

Embodiments of the invention may be implemented on virtually any type of computer regardless of the platform being used. For example, as shown in FIG. 9, a computer system (900) includes a processor (902), associated memory (904), a storage device (906), and numerous other elements and functionalities typical of today's computers (not shown). The computer (900) may also include input means, such as a keyboard (908) and a mouse (910), and output means, such as a monitor (912). The computer system (900) is connected to a local area network (LAN) or a wide area network (e.g., the Internet) (not shown) via a network interface connection (not shown). Those skilled in the art will appreciate that these input and output means may take other forms.

Further, those skilled in the art will appreciate that one or more elements of the aforementioned computer system (900) may be located at a remote location and connected to the other elements over a network. Further, embodiments of the invention may be implemented on a distributed system having a plurality of nodes, where each portion of the invention (e.g., data source, data management system, etc.) may be located on a different node within the distributed system. In one embodiment of the invention, the node is a computer system. Alternatively, the node may be a processor with associated physical memory. The node may alternatively be a processor with shared memory and/or resources. Further, software instructions to perform embodiments of the invention may be stored on a computer readable medium such as a compact disc (CD), a diskette, a tape, a file, or any other computer readable storage device.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for categorization of transactions, comprising:
receiving a request for a transaction from a user of a plurality of users;
determining an availability of an object association for an object name of an object of the transaction, wherein the object association is a preferred object association of the user;
selecting a collaborative object association for the object name when the preferred object association of the user is not available, wherein the collaborative object association is selected based on the preferred object association of the plurality of users for the object name; and
providing the collaborative object association to the user.

2. The method of claim 1, wherein the object name is a normalized object name.

3. The method of claim 2, wherein the transaction is a financial transaction, the object is a payee of the financial transaction, the normalized object name is a normalized payee name based on a name for the payee comprised in the financial transaction, and an object association comprises a payee name and a payee category.

4. The method of claim 1, further comprising:
receiving a new object association from the user, wherein the new object association is designated as the preferred object association of the user.

5. The method of claim 1, further comprising:
receiving an indication from the user designating the collaborative object association as the preferred object association of the user.

6. The method of claim 1, wherein selecting the collaborative object association further comprises:
selecting an object association from the preferred object associations for the object name of the user as the collaborative object association, wherein the object association is a preferred object association for a majority of users.

7. The method of claim 1, further comprising:
receiving a plurality of requests for transactions comprising the object, wherein the preferred object association for the object name is changed resulting in a changed preferred object association;
receiving a subsequent request for a transaction comprising the object from a new user;
selecting a selected collaborative object association for the object name, wherein the selected collaborative object association is selected based on the changed preferred object association; and
providing the selected collaborative object association to the new user.

8. The method of claim 1, further comprising:
providing the preferred object association of the user to the user when the preferred object association of the user is available.

9. The method of claim 8, further comprising:
receiving an indication from the user that the user wishes to select a different object association for the object name; and
providing a plurality of object associations for the object name to the user.

10. The method of claim 9, wherein the plurality of object associations comprises a plurality of preferred object associations of the user, wherein the plurality of object associations is ranked according to a time each of the plurality of preferred object associations was previously used by the user.

11. The method of claim 10, wherein the plurality of object associations further comprises a plurality of preferred object associations of other users in the plurality of users, wherein the plurality of object associations is further ranked according to a number of the other users that specified each of the plurality of preferred object associations of other users as a preferred object association.

12. A computer readable medium comprising computer program code for categorization of transactions under control of a processor, the computer program code comprising instructions to:
receive a request for a transaction from a user of a plurality of users;
determine an availability of an object association for an object name of an object of the transaction, wherein the object association is a preferred object association of the user;
select a collaborative object association for the object name when the preferred object association of the user is not available, wherein the collaborative object association is selected based on the preferred object association of the plurality of users for the object name; and
provide the collaborative object association to the user.

13. The computer readable medium of claim 12, wherein the object name is a normalized object name.

14. The computer readable medium of claim 13, wherein the transaction is a financial transaction, the object is a payee of the financial transaction, the normalized object name is a normalized payee name based on a name for the payee comprised in the financial transaction, and an object association comprises a payee name and a payee category.

15. The computer readable medium of claim 12, the computer program code further comprising instructions to:
receive a new object association from the user, wherein the new object association is designated as the preferred object association of the user.

16. The computer readable medium of claim 12, the computer program code further comprising instructions to:
receive an indication from the user designating the collaborative object association as the preferred object association of the user.

17. The computer readable medium of claim 12, wherein the instructions to select the collaborative object association further comprise instructions to:
select an object association from the preferred object associations for the object name of the user as the collaborative object association, wherein the object association is a preferred object association for a majority of users.

18. The computer readable medium of claim 12, the computer program code further comprising instructions to:
receive a plurality of requests for transactions comprising the object, wherein the preferred object association for the object name is changed resulting in a changed preferred object association;
receive a subsequent request for a transaction comprising the object from a new user;
select a selected collaborative object association for the object name, wherein the selected collaborative object association is selected based on the changed preferred object association; and
provide the selected collaborative object association to the new user.

19. A method for categorization of transactions, comprising:
obtaining a plurality of preferred object associations for an object name from a plurality of users, wherein the plurality of preferred object associations are provided by the plurality of users responsive to requests by the plurality of users for transactions comprising an object having the object name;
determining a first majority object association from the plurality of preferred object associations based on a number of the plurality of users providing the first majority object association as a preferred object association;
receiving a subsequent request for a transaction comprising the object from a new user; and
providing the first majority object association to the new user.

20. The method of claim 19, wherein the transactions are financial transactions, the object is a payee of the financial transactions, the object name is a normalized payee name based on names for the payee comprised in the financial transactions, and an object association comprises a payee name and a payee category.

21. The method of claim 19, further comprising:
determining a second majority object association from the plurality of preferred object associations based on an equal number of the plurality of users providing the second majority object association as a preferred object association as the number of the plurality of users providing the first majority object association; and
providing the second majority association to the new user instead of the first majority object association based on times the first majority association and the second majority association are provided as preferred object associations.

22. A method for categorization of transactions comprising:
requesting a transaction from a transaction management system;
receiving an object association for an object name of an object of the transaction, wherein the object association is a collaborative object association for the object name, and wherein the collaborative object association is selected based on a plurality of preferred object associations for the object name of a plurality of users of the transaction management system; and
providing a different object association to the transaction management system when the object association is not acceptable.

23. The method of claim 22, further comprising:
indicating acceptance of the object association to the transaction management system, wherein the object association is designated as a preferred object association of a user from the plurality of preferred object associations.

24. The method of claim 22, wherein the transaction is a financial transaction, the object is a payee of the financial transaction, the object name is a normalized payee name based on a name for the payee comprised in the financial transaction, and an object association comprises a payee name and a payee category.

25. The method of claim 22, wherein providing the different object association further comprises:
receiving a plurality of object associations for the object name from the transaction management system; and
selecting the different object association from the plurality of object associations, wherein the different object association is designated as a preferred object association of a user from the plurality of preferred object associations.

26. The method of claim 25, wherein the plurality of object associations comprises the plurality of preferred object associations.

27. The method of claim 25, wherein the plurality of object associations is selected from the plurality of preferred object associations based on validity of each of the preferred object associations.

28. The method of claim 22, wherein the collaborative object association is a preferred object association for a majority of the plurality of users.

29. The method of claim 22,
wherein a first preferred object association of the plurality of preferred object associations is a preferred object association for a first number of the plurality of users and a second preferred object association of the plurality of preferred object associations is a preferred object association for a second number of the plurality of users, wherein the first number is equal to the second number, and
wherein one of first preferred object association and the second preferred object association is selected as the collaborative object association based on a first time the first preferred object association was last selected as a preferred object association and a second time the second preferred object association was last selected as a preferred object association.

30. A transaction management system for categorization of transactions, comprising:
a user data repository comprising a plurality of preferred object associations for an object name provided by a plurality of users of the transaction management system, wherein each of the plurality of preferred object associations corresponds to one of the plurality of users, and wherein the plurality of preferred object associations are provided by the plurality of users responsive to requests by the plurality of users for transactions comprising an object having the object name;
a collaborative object repository comprising a plurality of object associations for the object name, wherein each of the plurality of preferred object associations corresponds to one of the plurality of preferred object associations; and
a recognition and association system configured to:
receive a request for a transaction comprising the object from a user of a plurality of users;
determine an availability of a preferred object association corresponding to the user in the user data repository;
select a collaborative object association for the object name of the object when the preferred object association corresponding to the user is not available, wherein the collaborative object association is selected based on the plurality of preferred object associations; and
provide the collaborative object association to the user.

31. The transaction management system of claim 30, wherein the object name is a normalized object name.

32. The transaction management system of claim 31, wherein the transactions are financial transactions, the object is a payee of the financial transaction, the normalized object name is a normalized payee name based on names for the payee comprised in the financial transactions, and an object association comprises a payee name and a payee category.

33. The transaction management system of claim 30, wherein the recognition and association system is further configured to:
receive a new object association from the user, wherein the new object association is stored in the user data repository as the preferred object association corresponding to the user.

34. The transaction management system of claim 30, wherein the recognition and association system is further configured to:
receive an indication from the user designating the collaborative object association as the preferred object association of the user, wherein the collaborative object association is set as the preferred object association corresponding to the user in the user data repository.

35. The transaction management system of claim 30, wherein the recognition and association system is further configured to:
provide a plurality of object associations for the object name from the collaborative object repository; and
receive an object association selected from the plurality of object associations from the user, wherein the selected object association is set as the preferred object association corresponding to the user in the user data repository.

36. The transaction management system of claim 30, wherein the recognition and association system is further configured to select the collaborative object association by selecting an object association from the collaborative object repository as the collaborative object association, wherein the object association is a preferred object association for a majority of the plurality of users.

37. The transaction management system of claim 30, wherein the recognition and association system is further configured to:
receive a plurality of requests for transactions comprising the object from the plurality of users, wherein at least some of the preferred object associations of the plurality of users are changed in the user data repository resulting in a changed preferred object association;
receive a subsequent request for a transaction comprising the object from a new user;
select a selected collaborative object association for the object name, wherein the selected collaborative object association is selected based on the changed preferred object association; and
provide the selected collaborative object association to the new user.

38. A data representation for use by a transaction management system to determine a collaborative object association for an object name of an object in a transaction, the data representation comprising:
an object association table comprising a plurality of object name and object association pairs, wherein each object name and object association pair corresponds to an object name and object association pair selected by at least one user of a plurality of users of the transaction management system as a preferred object association for the object name of the object; and
a user preference table comprising a plurality of mappings of the plurality of users to the plurality of object name and object association pairs in the object association table, wherein each mapping associates a user of the plurality of users with an object name and object association pair in the object association table, and wherein the mapping denotes that the object name and object association pair is a preferred object association of the user for the object name of the object,
wherein when the transaction management system receives the object in a transaction responsive to a request for the transaction from a user of the plurality of users, the transaction management system uses:
the user preference table for determining whether the user has a preferred object association for the object name of the object; and
the object association table for choosing an object name and object association pair as a collaborative object association for the object name of the object.

39. The data representation of claim 38, wherein the transaction is a financial transaction, the object is a payee of the financial transaction, the object name is a normalized payee name based on a name for the payee comprised in the financial transaction, and an object name and object association pair is a payee name and payee category pair.
